(19) United States
(12) Patent Application Publication
(10) Pub. No.: US 2026/0111195 A1
(43) Pub. Date: Apr. 23, 2026

(54) MOCK APPLICATION PROGRAMMING INTERFACE (API) GENERATION

(71) Applicant: Capital One Services, LLC, McLean, VA (US)

(72) Inventors: Shahryar RASHID, Plano, TX (US); Alex ERINGIS, Plano, TX (US)

(73) Assignee: Capital One Services, LLC, McLean, VA (US)

(21) Appl. No.: 18/918,719

(22) Filed: Oct. 17, 2024

(51) Int. Cl. G06F 8/41; G06F 8/35; G06F 11/36

(52) U.S. Cl. CPC G06F 8/41; G06F 8/35; G06F 11/3688

(57) ABSTRACT

Disclosed herein are a system, method, and computer program product embodiments for generating a mock API. For example, API models may be generated based on the specification of the API. For each of the API models, respective object-generating code may be generated. The respective object-generating code for each of the API models may be configured to generate objects associated with a corresponding API model. The respective object-generating code for each of the API models may be configured to generate synthetic data for the objects generated thereby. The respective object-generating code for each of the plurality of API models may be compiled to generate a mock API.

### BACKGROUND

Application programming interfaces (APIs) generally expose various routines and methods to software developers. These APIs may be accessible programmatically (e.g., as function calls programmed in an application or function library) or via a web resource for web-based applications. Web-based applications can invoke functionality exposed by an API, for example, using a Representational State Transfer function call (a REST call), queries in an HTTP POST request, a Simple Object Access Protocol (SOAP) request, or other protocols that allow client software to invoke functions on a remote system.

Programmers often write code that integrates with other components via APIs. During the development process, however, these components may not yet be available. Therefore, programmers may configure mock servers to simulate external API components. However, such a process is very tedious and prone to error. This may result in inadequate testing of an application that interfaces with the APIs being mocked, and therefore, results in software bugs going undetected.

### BRIEF SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Disclosed herein are system, apparatus, device, method and/or computer program product embodiments, and/or combinations and sub-combinations thereof for generating mock APIs.

In one or more embodiments, a method for generating a mock API is performed. The method includes: generating a plurality of application programming interface (API) models based on a specification of the API; generating respective object-generating code for each of the plurality of API models, wherein the respective object-generating code for each of the plurality of API models is configured to generate objects associated with a corresponding API model of the plurality of API models; configuring the respective object-generating code for each of the plurality of API models to generate synthetic data for the objects generated thereby; and compiling the respective object-generating code for each of the plurality of API models to generate a mock API.

In one or more embodiments, generating the respective object-generating code for each of the plurality of API models comprises: ranking each API model of the plurality of API models based on the specification of the API; and ordering the respective object-generating code for each of the plurality of API models based on the ranking to generate an ordered set of object-generating code.

In one or more embodiments, compiling the respective object-generating code for each of the plurality of API models comprises: compiling the respective object-generating code for each of the plurality of API models based on the ordered set of object-generating code.

In one or more embodiments, ranking each API model of the plurality of API models based on the specification of the API comprises: determining a number of references associated with each API model of the plurality of API models based on the specification of the API; and ranking each API model of the plurality of API models based on a number of references associated with each API model of the plurality of API models.

In one or more embodiments, configuring the respective object-generating code for each of the plurality of API models to generate synthetic data for the objects generated thereby comprises: determining at least one of a data type or name of the objects based on the specification of the API; and configuring the respective object-generating code for each of the plurality of API models to generate synthetic data based on the determined at least one of the data type or the name of the objects.

In one or more embodiments, the method further includes: causing a script to be executed that modifies responses that are output from the mock API.

In one or more embodiments, the synthetic data is randomly-generated data, and configuring the respective object-generating code for each of the plurality of API models to generate synthetic data for the objects generated thereby comprises: providing a configuration file that specifies one or more constraints for the randomly-generated data.

In one or more embodiments, a computing system for generating a mock API is provided. The computing system includes one or more memories, and at least one processor coupled to the one or more memories and configured to perform operations. The operations include: generating a plurality of application programming interface (API) models based on a specification of the API; generating respective object-generating code for each of the plurality of API models, wherein the respective object-generating code for each of the plurality of API models is configured to generate objects associated with a corresponding API model of the plurality of API models; configuring the respective object-generating code for each of the plurality of API models to generate synthetic data for the objects generated thereby; and compiling the respective object-generating code for each of the plurality of API models to generate a mock API.

In one or more embodiments, generating the respective object-generating code for each of the plurality of API models comprises: ranking each API model of the plurality of API models based on the specification of the API; and ordering the respective object-generating code for each of the plurality of API models based on the ranking to generate an ordered set of object-generating code.

In one or more embodiments, compiling the respective object-generating code for each of the plurality of API models comprises: compiling the respective object-generating code for each of the plurality of API models based on the ordered set of object-generating code.

In one or more embodiments, ranking each API model of the plurality of API models based on the specification of the API comprises: determining a number of references associated with each API model of the plurality of API models based on the specification of the API; and ranking each API model of the plurality of API models based on a number of references associated with each API model of the plurality of API models.

In one or more embodiments, configuring the respective object-generating code for each of the plurality of API models to generate synthetic data for the objects generated thereby comprises: determining at least one of a data type or name of the objects based on the specification of the API; and configuring the respective object-generating code for each of the plurality of API models to generate synthetic data based on the determined at least one of the data type or the name of the objects.

In one or more embodiments, the operations further include: causing a script to be executed that modifies responses that are output from the mock API.

In one or more embodiments, the synthetic data is randomly-generated data, and configuring the respective object-generating code for each of the plurality of API models to generate synthetic data for the objects generated thereby comprises: providing a configuration file that specifies one or more constraints for the randomly-generated data.

In one or more embodiments, a non-transitory computer readable medium including instructions for causing a processor to perform operations is provided. The operations include: generating a plurality of application programming interface (API) models based on a specification of the API; generating respective object-generating code for each of the plurality of API models, wherein the respective object-generating code for each of the plurality of API models is configured to generate objects associated with a corresponding API model of the plurality of API models; configuring the respective object-generating code for each of the plurality of API models to generate synthetic data for the objects generated thereby; and compiling the respective object-generating code for each of the plurality of API models to generate a mock API.

In one or more embodiments, generating the respective object-generating code for each of the plurality of API models comprises: ranking each API model of the plurality of API models based on the specification of the API; and ordering the respective object-generating code for each of the plurality of API models based on the ranking to generate an ordered set of object-generating code.

In one or more embodiments, compiling the respective object-generating code for each of the plurality of API models comprises: compiling the respective object-generating code for each of the plurality of API models based on the ordered set of object-generating code.

In one or more embodiments, ranking each API model of the plurality of API models based on the specification of the API comprises: determining a number of references associated with each API model of the plurality of API models based on the specification of the API; and ranking each API model of the plurality of API models based on a number of references associated with each API model of the plurality of API models.

In one or more embodiments, configuring the respective object-generating code for each of the plurality of API models to generate synthetic data for the objects generated thereby comprises: determining at least one of a data type or name of the objects based on the specification of the API; and configuring the respective object-generating code for each of the plurality of API models to generate synthetic data based on the determined at least one of the data type or the name of the objects.

In one or more embodiments, the operations further include: causing a script to be executed that modifies responses that are output from the mock API.

### BRIEF DESCRIPTION OF THE DRAWINGS

The accompanying drawings are incorporated herein and form a part of the specification.

FIG. 1 shows a block diagram of a system configured to generate a mock API, according to some embodiments.

FIG. 2 shows a block diagram of a mock API generator, according to some embodiments.

FIG. 3 is a flowchart of a method for generating a mock API, according to some embodiments.

FIG. 4 is a flowchart of a method for generating object-generating code, according to some embodiments.

FIG. 5 is a flowchart of a method for ranking API models, according to some embodiments.

FIG. 6 is a flowchart of a method for configuring object-generating code to generate synthetic data, according to some embodiments.

FIG. 7 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

As discussed in the Background Section above, the configuration of mock servers is a tedious process that is prone to error. This may result in inadequate testing of an application that interfaces with the APIs being mocked, and therefore, results in software bugs going undetected. These challenges necessitate the automated generation of mock APIs that accurately model the behavior of APIs.

As will be described herein, a system, method and computer program product for generating a mock API are provided that addresses these issues. In particular, embodiments described herein generate a mock API based on an automated analysis of the specification of the API. For instance, API models may be generated based on the specification of the API. For each of the API models, respective object-generating code may be generated. The respective object-generating code for each of the API models may be configured to generate objects associated with a corresponding API model. The respective object-generating code for each of the API models may be configured to generate synthetic data for the objects generated thereby. The respective object-generating code for each of the plurality of API models may be compiled to generate a mock API.

In some embodiments, the synthetic data that is generated by a mock API may be constrained so that the synthetic data is contextually-relevant to requests received thereby. For instance, a user may declaratively define constraints for the synthetic data via a configuration file that is applied by the mock API.

The embodiments described herein advantageously generate a mock API that accurately models the behavior of an API. This allows for better test coverage for an application and helps identify more bugs. Such bugs, if undetected, can degrade the performance of the computing device on which the application executes. For instance, such bugs may cause an excess usage of memory or power or an increase in processing cycles or network bandwidth. By finding and fixing the bugs before the application is released, performance degradation of the computing device may be mitigated. Accordingly, the techniques described herein improve the functioning of a computing system on which the application executes, as excess usage of various compute resources (e.g., memory, storage, processing cycles, power, etc.) may be reduced.

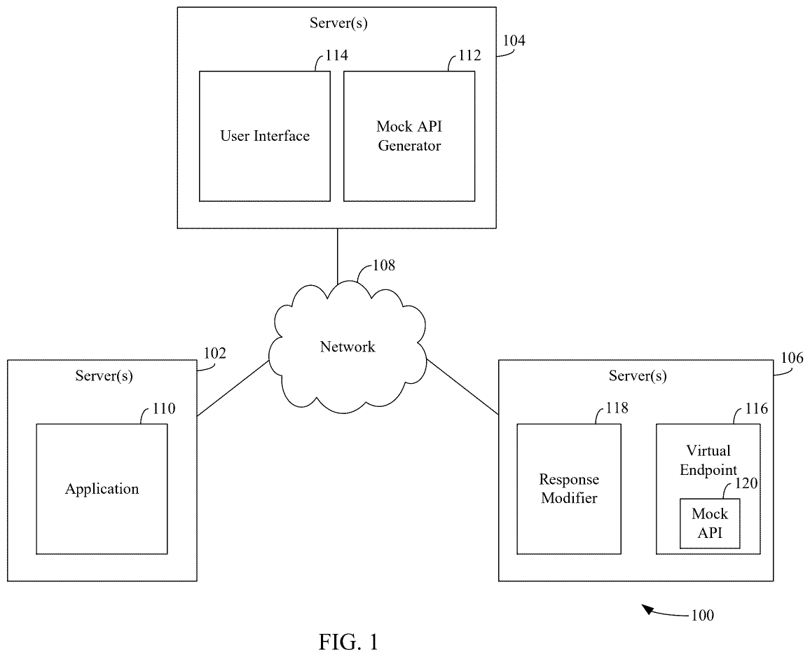

To further illustrate the foregoing, reference is now made to FIG. 1, which is a block diagram of a system 100 configured to generate a mock API, according to some embodiments. As shown in FIG. 1, system 100 includes one or more servers 102, server(s) 104, and server(s) 106. Server(s) 102, 104, and 106 may be communicatively coupled to each other via a network 108. Network 108 may comprise one or more networks such as local area networks (LANs), wide area networks (WANs), enterprise networks, the Internet, etc., and may include one or more of wired and/or wireless portions.

In an embodiment, server(s) 102, 104, and 106 may form a network-accessible server set (e.g., a cloud-based environment or platform). Server(s) 102, 104, and 106 may be accessible via network 108 (e.g., in a “cloud-based” embodiment) to build, deploy, and manage applications and services. Server(s) 102, 104, and 106 may be co-located (e.g., housed in one or more nearby buildings with associated components such as backup power supplies, redundant data communications, environmental controls, etc.) to form a datacenter, or may be arranged in other manners. Accordingly, in an embodiment, server(s) 102, 104, and 106 may be a datacenter in a distributed collection of datacenters.

Each of server(s) 102, 104, and 106 may be configured to include and execute one or more software applications (or “applications”) and/or services. For example, as shown in FIG. 1, server(s) 102 may be configured to include an application 110. Application 110 may comprise any software application that is under development and/or test. In some embodiments, application 110 may be configured to store, manage, and/or process data related to applying for a loan and/or purchasing a product, such as a vehicle. Application 110 may be configured to transmit data to and/or receive data from one or more data sources, including, but not limited, databases, web services, etc. Application 110 may communicate with such data source(s) via APIs. During development and testing of application 110, application 110 may be configured to transmit data to and/or receive data from mock APIs that simulate the behavior of APIs used by data source(s).

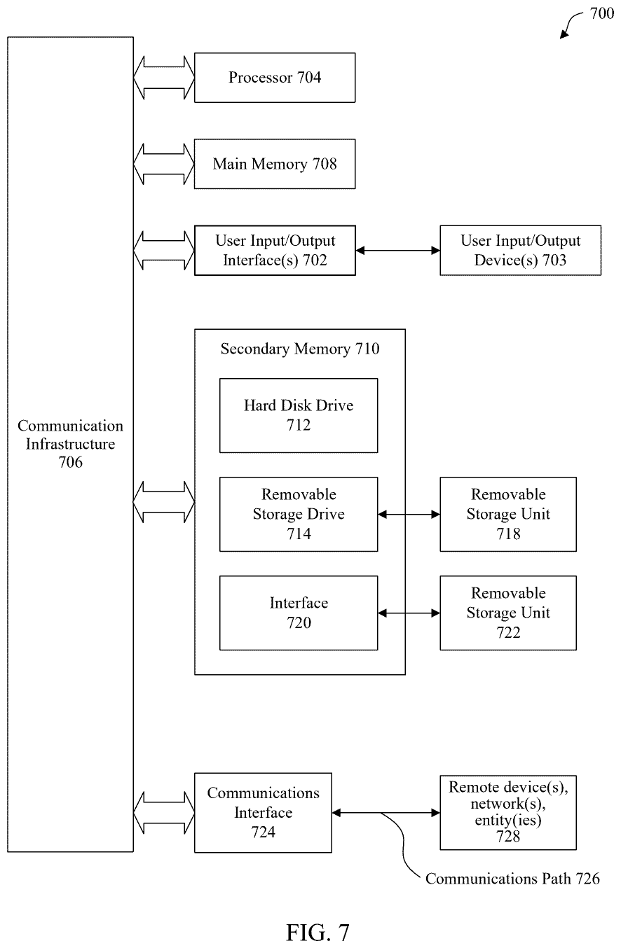

Server(s) 104 may be configured to execute a mock API generator 112 that is configured to generated a mock API. Mock API generator 112 may be implemented by processing logic that can comprise hardware (e.g., circuitry, dedicated logic, programmable logic, microcode, etc.), software (e.g., instructions executing on a processing device), or a combination thereof. In an embodiment, mock API generator 112 is implemented in one or more software processes executing on one or more processor-based computer systems, such as computer system 700 as described below in reference to FIG. 7.

Mock API generator 112 may be configured to receive, as an input, an API specification and generate one or more API models (also referred herein as “data model(s)”). An API model may comprise a structured representation of data objects and their relationships within the API. The API model may encapsulate both the format and schema of the data used in the API. This may include the identification of data types, the definition of data structures, the relationships between these structures, and the names of the data objects. In one example, an API model may specify API calls configured to be generated by the API model, a payload of such API calls, endpoint(s) to which such API calls can be placed, etc. The API model may also indicate the data objects included in the payload (e.g., a user name, an address, income, phone number, etc.). For each generated API model, mock API generator 112 may be configured to generate code that is configured to generate instances of data objects for the API model. Such code is referred herein as object-generating code. In an example in which an API model corresponds to a user, a vehicle, etc., the object-generating code may generate instances of data objects corresponding to a user, a vehicle, etc. In an embodiment in which application is a Python-based application, the object-generating code for a particular API model is a factory that comprises a set of attributes used to instantiate an object. Each of the set of attributes may be overridden by passing keyword arguments to the factory. For instance, a factory configured to generate a user object may default to generating a user object with a first name attribute of “John” and a second name attribute of “Doe.” name “John Doe.” The first name and/or second name attributes may be overridden by passing keyword arguments corresponding to a different first name and/or second name.

Mock API generator 112 may configure each object-generating code to generate synthetic (also referred herein as “fake” or “simulated”) data for the objects generated thereby. For instance, mock API generator 112 may generate code that generates synthetic data for a particular object. In an embodiment, in which the object-generating code is a factory, mock API generator 112 may replace the value assigned to an attribute (e.g., “John”) with a function call to a function that generates synthetic data (e.g., fake first names). Mock API generator 112 may compile the object-generated code generated for each of the API models to generate a mock API 120.

As shown in FIG. 1, mock API 120 may be deployed on and executed by a virtual endpoint 116, which executes on server(s) 106. Virtual endpoint 116 is network-accessible via network 108 and is configured to emulate a data source (e.g., a database, a web service, etc.) that application 110 is configured to communicate with when it executes in a development environment.

As described above, the synthetic data generated by the object-generating code may be randomly-generated data. The randomly-generated data may be not be constrained and may comprise any format and/or value, and as such, may not be contextually-relevant. For instance, suppose application 110 requests a vehicle identification number (VIN) of a vehicle, which typically comprises a combination of alphanumeric characters. In some instances, the data randomly-generated by the mock API may comprise only numeric characters, which does not accurately represent a VIN number. To prevent the generation of contextually-irrelevant data, a user may utilize a user interface 114 associated with mock API generator 112 that enables a user to specify constraints for the data that is generated by object-generating code. The constraints may be specified in a declarative fashion via a configuration file that is loaded by mock API 120. For instance, using user interface 114, the user may specify, for object-generating code for a particular API model, a format in which data is to be generated, a range of values for the randomly-generated data (e.g., values between 0 and 10,000), etc.

User interface 114 may also enable a user to specify whether data generated by object-generating code is to be encrypted. For instance, using user interface 114, the user may specify which attributes of an object generated by mock API 120 is to be encrypted by mock API 120. User interface 114 may further enable a user to inject a response modifier 118 that modifies the data generated and output by mock API 120. For instance, response modifier 118 may be configured to modify certain data such that it echoes data provided to mock API 120. For instance, application 110 may issue a request to mock API 120 that comprises a request identifier (ID), which is to be echoed in a response (e.g., as a response ID) to the request. This way, application 110 may associate the response to the request. Response modifier 118 may receive the response from the mock API, which may comprise a randomly-generated response ID. Response modifier 118 may modify the randomly-generated response ID so that it equals the request ID. In another example, a request for a loan application generated by application 110 may include a timestamp indicative of when the loan application was submitted. The payload of a response to the request normally includes a timestamp, for example, indicative when a loan application was reviewed, when an offer will expire, etc. Response modifier 118 may modify the response generated by mock API 120 such that the timestamp included therein (which is randomly-generated by mock API 120) indicates a date and/or time that is after the date and/or time indicated by the timestamp included in the request. In some embodiments, response modifier 118 is implemented as a script (e.g., a JavaScript-based script) or may cause a script configured to modify responses generated by mock API 120 to be executed.

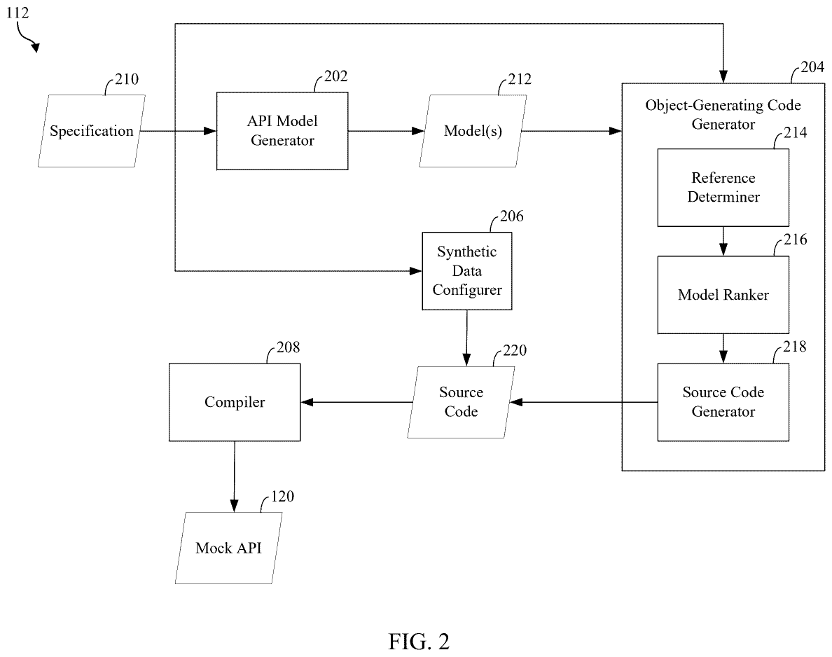

FIG. 2 shows a block diagram of mock API generator 112, according to some embodiments. As shown in FIG. 2, mock API generator 112 may include an API model generator 202, an object-generating code generator 204, a synthetic data configurer 206, and a compiler 208. Each of API model generator 202, object-generating code generator 204, synthetic data configurer 206, and compiler 208 may be implemented by processing logic that can comprise hardware (e.g., circuitry, dedicated logic, programmable logic, microcode, etc.), software (e.g., instructions executing on a processing device), or a combination thereof. In an embodiment, each of API model generator 202, object-generating code generator 204, synthetic data configurer 206, and compiler 208 is implemented in one or more software processes executing on one or more processor-based computer systems, such as computer system 700 as described below in reference to FIG. 7.

API model generator 202 may be configured to receive, as an input, an API specification 210. API specification 210 may define the functionality of an API. API specification 210 may include a technical description of how the API operates, detailing its operations, accessible endpoints, input(s) and output(s) for each call, and the data models it employs. API specification 210 may be in a machine-readable and/or human-readable format, such as a Yet Another Markup Language (YAML)-based format, a JavaScript Object Notation (JSON)-based format, etc. API model generator 202 may be configured to generate source code corresponding to API model(s) 212 specified by API specification 210. For instance, API model generator 202 may parse API specification 210 to determine API model(s) 212 of API specification 210 and generate source code therefor.

Object-generating code generator 204 may include a reference determiner 214, a model ranker 216, and a source code generator 218. Reference determiner 214 may be configured to receive, as an input, API specification 210. Reference determiner 214 may parse API specification 210 to determine a number of references associated with each API model specified by API specification 210. For instance, for each API model, reference determiner 214 may determine the number of other API models that reference the API model. For each of API model(s) 212, reference determiner 214 may provide an indication of the number of references associated therewith to model ranker 216.

Model ranker 216 may rank each API model of API model(s) 212 based on the number of references associated with each API model. For instance, model ranker 216 may sort each API model based on the number of references associated therewith, where the API model with the most number of references is ranked first, and the API model with the least number of references is ranked last. In some embodiments, model ranker 216 may utilize a reverse page rank-based technique to determine the ranking for each of API model(s) 212. In accordance with such an embodiment, a directed graph comprising nodes representative of each API model may be generated. Each incoming edge to a particular node may indicate a reference to the corresponding API model. The number of incoming edges may correspond to the total number of references to that API model. Model ranker 216 may provide a ranked list of API model(s) 212 to source code generator 218.

Source code generator 218 may be configured to generate object-generating source code for each of API model(s) 212 based on the ranked list of API model(s) 212 provided by model ranker 216. For instance, source code generator 218 may order the respective object-generating source code for each API model(s) 212 based on the ranking to generate an ordered set of object-generating source code 220. In an embodiment in which object-generating source code is compiled serially line-by-line, this advantageously ensures that the respective pieces of object-generating source code are generated in the correct order and that the ordered set of object-generating source code 220 compiles successfully. That is, compiler 208 will not encounter object-generating source code that has not been fully defined.

Synthetic data configurer 206 may be configured to configure the respective object-generating source code for each of API model(s) 212 to generate synthetic data for the objects generated thereby. For instance, synthetic data configurer 206 may receive, as an input, API specification 210 and parse API specification 210 to determine one or more characteristics of the data objects specified by API specification 210. Such characteristic(s) include, but are not limited to, a data type and/or a name of the data object. In some embodiments, synthetic data configurer 206 may utilize natural language processing-based techniques to parse API specification 210 and determine the intended data type and/or name of the data object (e.g., when user-defined constraints are otherwise not present). Synthetic data configurer 206 may inject code in the respective object-generating source code 220 for each of API model(s) 212 that generates synthetic data for the data objects thereby in accordance with the determined characteristic(s) such data objects. The injected code may comprise a call to a synthetic data generation function associated with the determined name. For instance, each synthetic data generation function may be configured to generate a particular type of synthetic data (e.g., a name, a phone number, an address, etc.). The synthetic data generation function to be utilized for a particular object may be inferred based on the determined name of the particular data object. The data type of the synthetic data to be generated by the determined synthetic data generation function may be determined based on the determined data type (e.g., an integer, a string, etc.) for a particular data object.

Compiler 208 may be configured to receive, as an input, the ordered set of object-generating source code 220 and compile the ordered set of object-generating source code 220 in accordance with the order in which the respective pieces of object-generating source code are organized to generate mock API 120.

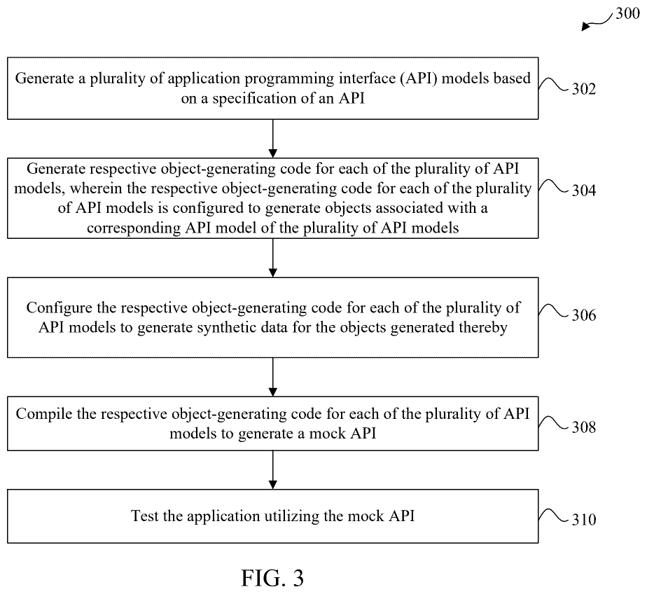

FIG. 3 is a flowchart of a method 300 for generating a mock API, according to some embodiments. Method 300 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein.

Further, some of the steps may be performed simultaneously, or in a different order than shown in FIG. 3, as will be understood by a person of ordinary skill in the art.

Method 300 shall be described with reference to FIG. 2. However, method 300 is not limited to that example embodiment.

In 302, API model generator 202 may generate a plurality of API models 212 based on a specification of an API (e.g., API specification 210).

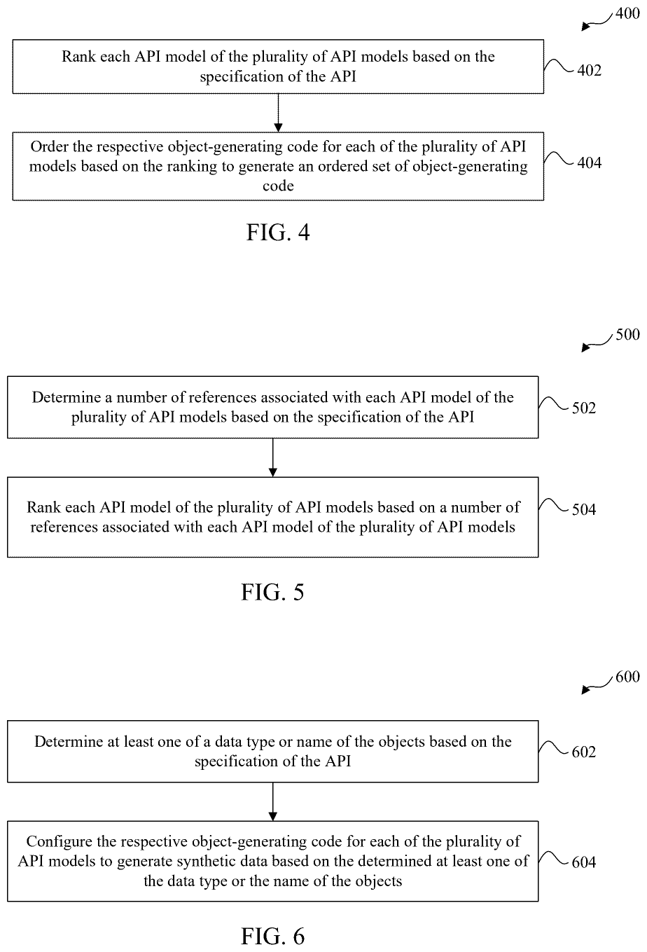

In 304, object-generating code generator 204 may generate respective object-generating code for each of the plurality of API models 212, wherein the respective object-generating code for each of the plurality of API models 212 is configured to generate objects associated with a corresponding API model of the plurality of API models 212. Additional details regarding generating object-generating code are provided below with reference to FIG. 4.

At 306, synthetic data configurer 206 may configure the respective object-generating code for each of the plurality of API models 212 to generate synthetic data for the objects generated thereby. Additional details regarding configuring the respective object-generating code are provided below with reference to FIG. 6.

In some embodiments, the synthetic data is randomly-generated data. The respective object-generating code for each of the plurality of API models 212 may be configured to generate synthetic data for the objects generated thereby by providing a configuration file that specifies one or more constraints for the randomly-generated data. For instance, with reference to FIG. 1, user interface 114 may be utilized to generate the configuration file and upload the configuration file to virtual endpoint 116. Virtual endpoint 116 may apply the configuration file to mock API 120, and mock API 120 may generate data based on the constraints specified in the configuration file.

At 308, compiler 208 may compile the respective object-generating code for each of the plurality of API models 212 to generate mock API 120.

In some embodiments, responses that are output from mock API 120 may be modified. For example, with reference to FIG. 1, response modifier 118 may cause a script to be executed that modifies responses that are output from mock API 120.

After mock API 120 is generated, a user may test application 110 utilizing mock API 120. For instance, one or more test scripts may be executed that cause application 110 to transmit data to and/or receive data from mock API 120.

FIG. 4 is a flowchart of a method 400 for generating object-generating code, according to some embodiments. Method 400 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4, as will be understood by a person of ordinary skill in the art.

Method 400 shall be described with reference to FIG. 2. However, method 400 is not limited to that example embodiment.

At 402, model ranker 216 may rank each API model of the plurality of API models 212 based on the specification of the API (e.g., API specification 210). Additional details regarding ranking API models 212 are provided below with reference to FIG. 5

At 404, source code generator 218 may order the respective object-generating code for each of the plurality of API models 212 based on the ranking to generate an ordered set of object-generating code 220. In some embodiments, compiler 208 may compile the respective object-generating code for each of the plurality of API models 212 based on the ordered set of object-generating code 220.

FIG. 5 is a flowchart of a method 500 for ranking API models, according to some embodiments. Method 500 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein.

Further, some of the steps may be performed simultaneously, or in a different order than shown in FIG. 5, as will be understood by a person of ordinary skill in the art.

Method 500 shall be described with reference to FIG. 2. However, method 500 is not limited to that example embodiment.

At 502, reference determiner 214 may determine a number of references associated with each API model of the plurality of API models 212 based on the specification of the API (e.g., API specification 210).

At 504, model ranker 216 may rank each API model of the plurality of API models 212 based on a number of references associated with each API model of the plurality of API models 212. For example, model ranker 216 may sort each API model 212 based on the number of references associated therewith (as indicated by reference determiner 214). In some embodiments, model ranker 216 may utilize a reverse page rank-based technique to determine the ranking for each of API model(s) 212.

FIG. 6 is a flowchart of a method 600 for configuring object-generating code to generate synthetic data, according to some embodiments. Method 600 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 6, as will be understood by a person of ordinary skill in the art.

Method 600 shall be described with reference to FIG. 2. However, method 60 is not limited to that example embodiment.

At 602, synthetic data configurer 206 may determine at least one of a data type or name of the objects based on the specification of the API (e.g., API specification 210).

At 604, synthetic data configurer 206 may configure the respective object-generating code for each of the plurality of API models 212 to generate synthetic data based on the determined at least one of the data type or the name of the objects.

Various embodiments may be implemented, for example, using one or more well-known computer systems, such as computer system 700 shown in FIG. 7. One or more computer systems 700 may be used, for example, to implement any of the embodiments discussed herein, as well as combinations and sub-combinations thereof.

Computer system 700 may include one or more processors (also called central processing units, or CPUs), such as a processor 704. Processor 704 may be connected to a communication infrastructure or bus 706.

Computer system 700 may also include user input/output device(s) 703, such as monitors, keyboards, pointing devices, etc., which may communicate with communication infrastructure 706 through user input/output interface(s) 702.

One or more of processors 704 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 700 may also include a main or primary memory 708, such as random access memory (RAM). Main memory 708 may include one or more levels of cache. Main memory 708 may have stored therein control logic (i.e., computer software) and/or data.

Computer system 700 may also include one or more secondary storage devices or memory 710. Secondary memory 710 may include, for example, a hard disk drive 712 and/or a removable storage device or drive 714. Removable storage drive 714 may be a floppy disk drive, a magnetic tape drive, a compact disk drive, an optical storage device, tape backup device, and/or any other storage device/drive.

Removable storage drive 714 may interact with a removable storage unit 718. Removable storage unit 718 may include a computer usable or readable storage device having stored thereon computer software (control logic) and/or data. Removable storage unit 718 may be a floppy disk, magnetic tape, compact disk, DVD, optical storage disk, and/any other computer data storage device. Removable storage drive 714 may read from and/or write to removable storage unit 718.

Secondary memory 710 may include other means, devices, components, instrumentalities or other approaches for allowing computer programs and/or other instructions and/or data to be accessed by computer system 700. Such means, devices, components, instrumentalities or other approaches may include, for example, a removable storage unit 722 and an interface 720. Examples of the removable storage unit 722 and the interface 720 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 700 may further include a communication or network interface 724. Communication interface 724 may enable computer system 700 to communicate and interact with any combination of external devices, external networks, external entities, etc. (individually and collectively referenced by reference number 728). For example, communication interface 724 may allow computer system 700 to communicate with external or remote devices 728 over communications path 726, which may be wired and/or wireless (or a combination thereof), and which may include any combination of LANs, WANs, the Internet, etc. Control logic and/or data may be transmitted to and from computer system 700 via communication path 726.

Computer system 700 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 700 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 700 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 700, main memory 708, secondary memory 710, and removable storage units 718 and 722, as well as tangible articles of manufacture embodying any combination of the foregoing. Such control logic, when executed by one or more data processing devices (such as computer system 700), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 7. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A method, comprising:
generating a plurality of application programming interface (API) models based on a specification of an API;
generating respective object-generating code for each of the plurality of API models, wherein the respective object-generating code for each of the plurality of API models is configured to generate objects associated with a corresponding API model of the plurality of API models;
configuring the respective object-generating code for each of the plurality of API models to generate synthetic data for the objects generated thereby; and
compiling the respective object-generating code for each of the plurality of API models to generate a mock API.

2. The method of claim 1, wherein generating the respective object-generating code for each of the plurality of API models comprises:
ranking each API model of the plurality of API models based on the specification of the API; and
ordering the respective object-generating code for each of the plurality of API models based on the ranking to generate an ordered set of object-generating code.

3. The method of claim 2, wherein compiling the respective object-generating code for each of the plurality of API models comprises:
compiling the respective object-generating code for each of the plurality of API models based on the ordered set of object-generating code.

4. The method of claim 2, wherein ranking each API model of the plurality of API models based on the specification of the API comprises:
determining a number of references associated with each API model of the plurality of API models based on the specification of the API; and
ranking each API model of the plurality of API models based on a number of references associated with each API model of the plurality of API models.

5. The method of claim 1, wherein configuring the respective object-generating code for each of the plurality of API models to generate synthetic data for the objects generated thereby comprises:
determining at least one of a data type or name of the objects based on the specification of the API; and
configuring the respective object-generating code for each of the plurality of API models to generate synthetic data based on the determined at least one of the data type or the name of the objects.

6. The method of claim 1, further comprising:
causing a script to be executed that modifies responses that are output from the mock API.

7. The method of claim 1, wherein the synthetic data is randomly-generated data, and wherein configuring the respective object-generating code for each of the plurality of API models to generate synthetic data for the objects generated thereby comprises:
providing a configuration file that specifies one or more constraints for the randomly-generated data.

8. A computing system, comprising:
one or more memories;
at least one processor coupled to the one or more memories and configured to perform operations comprising:
generating a plurality of application programming interface (API) models based on a specification of an API;
generating respective object-generating code for each of the plurality of API models, wherein the respective object-generating code for each of the plurality of API models is configured to generate objects associated with a corresponding API model of the plurality of API models;
configuring the respective object-generating code for each of the plurality of API models to generate synthetic data for the objects generated thereby; and
compiling the respective object-generating code for each of the plurality of API models to generate a mock API.

9. The system of claim 8, wherein generating the respective object-generating code for each of the plurality of API models comprises:
ranking each API model of the plurality of API models based on the specification of the API; and
ordering the respective object-generating code for each of the plurality of API models based on the ranking to generate an ordered set of object-generating code.

10. The system of claim 9, wherein compiling the respective object-generating code for each of the plurality of API models comprises:
compiling the respective object-generating code for each of the plurality of API models based on the ordered set of object-generating code.

11. The system of claim 9, wherein ranking each API model of the plurality of API models based on the specification of the API comprises:
determining a number of references associated with each API model of the plurality of API models based on the specification of the API; and
ranking each API model of the plurality of API models based on a number of references associated with each API model of the plurality of API models.

12. The system of claim 8, wherein configuring the respective object-generating code for each of the plurality of API models to generate synthetic data for the objects generated thereby comprises:
determining at least one of a data type or name of the objects based on the specification of the API; and
configuring the respective object-generating code for each of the plurality of API models to generate synthetic data based on the determined at least one of the data type or the name of the objects.

13. The system of claim 8, the operations further comprising:
causing a script to be executed that modifies responses that are output from the mock API.

14. The system of claim 8, wherein the synthetic data is randomly-generated data, and wherein configuring the respective object-generating code for each of the plurality of API models to generate synthetic data for the objects generated thereby comprises:
providing a configuration file that specifies one or more constraints for the randomly-generated data.

15. A non-transitory computer readable medium including instructions for causing a processor to perform operations, the operations comprising:
generating a plurality of application programming interface (API) models based on a specification of an API;
generating respective object-generating code for each of the plurality of API models, wherein the respective object-generating code for each of the plurality of API models is configured to generate objects associated with a corresponding API model of the plurality of API models;
configuring the respective object-generating code for each of the plurality of API models to generate synthetic data for the objects generated thereby; and
compiling the respective object-generating code for each of the plurality of API models to generate a mock API.

16. The non-transitory computer readable medium of claim 15, wherein generating the respective object-generating code for each of the plurality of API models comprises:
ranking each API model of the plurality of API models based on the specification of the API; and
ordering the respective object-generating code for each of the plurality of API models based on the ranking to generate an ordered set of object-generating code.

17. The non-transitory computer readable medium of claim 16, wherein compiling the respective object-generating code for each of the plurality of API models comprises:
compiling the respective object-generating code for each of the plurality of API models based on the ordered set of object-generating code.

18. The non-transitory computer readable medium of claim 16, wherein ranking each API model of the plurality of API models based on the specification of the API comprises:
determining a number of references associated with each API model of the plurality of API models based on the specification of the API; and
ranking each API model of the plurality of API models based on a number of references associated with each API model of the plurality of API models.

19. The non-transitory computer readable medium of claim 15, wherein configuring the respective object-generating code for each of the plurality of API models to generate synthetic data for the objects generated thereby comprises:
determining at least one of a data type or name of the objects based on the specification of the API; and
configuring the respective object-generating code for each of the plurality of API models to generate synthetic data based on the determined at least one of the data type or the name of the objects.

20. The non-transitory computer readable medium of claim 15, the operations further comprising:
causing a script to be executed that modifies responses that are output from the mock API.
